(19) United States
(12) Patent Application Publication
(10) Pub. No.: US 2007/0187279 A1
(43) Pub. Date: Aug. 16, 2007

(54) Strip tape, a packaging container having such a strip tape, and a method of producing such a strip tape

(75) Inventors: Monica Zuppiger, Lausanne (CH); Hakan Olsson, Lund (SE); Ingemar Larsson, Fjallbacka (SE)

Correspondence Address: BUCHANAN, INGERSOLL & ROONEY PC, POST OFFICE BOX 1404, ALEXANDRIA, VA, 22313-1404, US

(73) Assignee: TETRA LAVAL HOLDINGS & FINANCE SA, Pully (CH)

(21) Appl. No.: 11/631,970

(22) PCT Filed: Sep. 5, 2005
(86) PCT No.: PCT/SE05/01276

§ 371 Date: Jan. 9, 2007

(30) Foreign Application Priority Data
Sep. 13, 2004 (SE) 0402215-8

(51) Int. Cl. B65D 85/84; B32B 27/32; B32B 27/40; B32B 27/34; B32B 27/36

(52) U.S. Cl. 206/524.2; 428/523; 428/516; 428/339; 428/423.1; 428/480; 428/474.4; 428/500; 428/220

(57) ABSTRACT

A strip tape has a structure, in order, comprising the following layers: a first layer with an outwardly facing surface of polypropylene; a first adhesive layer; a core layer of an oxygen barrier polymer; a second adhesive layer; and a second layer with an outwardly facing surface of polypropylene. In addition, a packaging container is provided with the strip tape to protect a longitudinal joint of the container, on the inside thereof. A method of producing the strip tape involves joining a first film having an outwardly facing surface of polypropylene to a first side of a core layer film having an oxygen barrier polymer by adhesive lamination with a first adhesive layer and joining a second film having an outwardly facing surface of polypropylene to a second side of the core layer film by adhesive lamination with a second adhesive layer.

### TECHNICAL FIELD

The present invention relates to a strip tape and to a packaging container having a container body formed from a packaging material comprising a paper or paperboard core layer and outer heat sealable layers of polypropylene (PP), having a longitudinal joint in which first and second longitudinal edges of the packaging material are overlapping each other and are heat sealed to each other such that said first longitudinal edge faces the interior of the container body, said first longitudinal edge being protected by a strip tape according to the invention, which strip tape is heat sealed in the area of the joint. The invention also relates to a method of producing the strip tape.

### PRIOR ART AND PROBLEMS

WO2003SE01793 describes a type of packaging container for liquid food, which makes use of heat sealing by induction. The packaging container consists of a first and a second container part that are heat sealed to each other. The first part is of tubular shape and has been formed from a sheet of packaging material coated with thermoplastics and having a core layer of paper or paperboard and at least one layer of aluminium foil. The sheet has a first sealed overlap longitudinal joint between two mutually opposed edge sections of the sheet. The edge in the longitudinal joint that faces the interior of the packaging container is protected from edge penetration into the paper or paperboard core layer, of the liquid food or by a sterilisation media, by a strip tape that is heat sealed to the area of the longitudinal joint on the inside of the packaging container. The second part, that consists of a plastic top having an opening device, is sealed by a second overlap joint, to the first part.

Edge protecting strip tapes for overlap joints are known also from other types of packaging containers having core layers of paper or paperboard. Such packaging containers may for example be aseptic (sterilised) or retortable packaging containers of Tetra Brik®-type, that are fold formed from a web of packaging material coated with thermoplastics and having a core layer of paper or paperboard and at least one layer of aluminium foil. In the high-speed, continuous packaging processes well known for the paperboard packages of the Tetra Brik®-type, a web of the packaging laminate is continuously formed into a tube, filled with contents and sealed off to pillow-shaped packaging containers by a simultaneous heat sealing and cutting operation. The pillow-shaped packaging container is then normally fold formed into a parallel-epipedic packaging container. The main advantage of this continuous tube-forming, filling and sealing packaging process concept is that the web may be sterilised continuously just before tube-forming, thus providing for the possibility of an aseptic packaging process, i.e. a process wherein the liquid content to be filled as well as the packaging material itself are reduced from bacteria and the filled packaging container is produced under clean circumstances such that the filled package may be stored for a long time even at ambient temperature, without the risk of growth of micro-organisms in the filled product. Variants also exist where the formed and sealed packaging container including its food content, is retorted.

Although strip tapes for protection of longitudinal joints in packaging containers of the types mentioned above are generally known, no strip tape exists that is especially adapted for such packaging containers in which the outer heat sealable layers consist of polypropylene (PP).

A strip tape for a PP-based packaging container should fulfil at least some, preferably all, of the following requirements:
Its oxygen barrier properties should be good and not be inferior to known PE-based strip tapes,
It should be resistant to aging and tropical storage conditions,
It should exhibit good runnability in the filling machine that forms, fills and seals the packaging container.

In connection with the development of the present invention, some different strip tape structures have been tested without good results. For example a co-extruded strip tape structure of PP/tie/EVOH/tie/PP blown film and a co-extruded strip tape structure of PP/tie/PA/tie/PP blown film both resulted in strip structure damages near the edge of the packaging material.

### BRIEF SUMMARY OF THE INVENTION

The present invention has for its object to provide a strip tape with outer surfaces of PP, which fulfils the above requirements, and to provide a packaging container having such a strip tape protecting its longitudinal joint.

These and other objectives are achieved by:

A strip tape having a structure of, in order, the following layers:
a first layer with an outwardly facing surface of polypropylene (PP),
a first adhesive layer,
a core layer of an oxygen barrier polymer,
a second adhesive layer,
a second layer with an outwardly facing surface of polypropylene (PP);

and by:

A packaging container having a container body formed from a packaging material comprising a paper or paperboard core layer and outer heat sealable layers of polypropylene (PP), having a longitudinal joint in which first and second longitudinal edges of the packaging material are overlapping each other and are heat sealed to each other such that said first longitudinal edge faces the interior of the container body, said first longitudinal edge being protected by a strip tape according to the invention, which strip tape is heat sealed in the area of the joint.

The invention also relates to:

A method of producing a strip tape, wherein a core layer film of an oxygen barrier polymer is coated on a first side thereof by a first adhesive layer, and on a second side thereof by a second adhesive layer, where after a first layer with an outwardly facing surface of polypropylene (PP) is extrusion coated onto said first adhesive layer and a second layer with an outwardly facing surface of polypropylene (PP) is extrusion coated onto said second adhesive layer;

alternatively to:

A method of producing a strip tape, wherein a core layer film of an oxygen barrier polymer is joined on a first side thereof with a first film with an outwardly facing surface of polypropylene (PP), by adhesive lamination there between with a first adhesive layer, and on a second side thereof with a second film with an outwardly facing surface of polypropylene (PP), by adhesive lamination there between with a second adhesive layer.

### DETAILED DESCRIPTION OF THE INVENTION

According to one aspect of the invention, the strip tape is symmetrical in structure and is composed of three pre-made films that are joined to each other by adhesive lamination by means of the adhesive layers, optionally by aid of electron beam curing. In the concept of “adhesive lamination” is included both lamination by means of coating or extrusion by liqueform (dispersion) or molten (extrusion) adhesive layers as well as lamination by mean of so called dry lamination.

As shall be understood from the below, some of the pre-made films may be composed of multi-layers.

According to an alternative aspect of the invention, the strip tape is symmetrical in structure and is formed from a single pre-made film (the core layer of an oxygen barrier polymer, which polymer is preferably but not necessarily extrudable) that is coated on both sides by the adhesive layers, where after the first and second layers with outwardly facing surfaces of PP are extrusion coated onto the adhesive layers. As shall be understood from the below, the first and second layers with outwardly facing surfaces of PP may be composed of multi-layers.

Thus, according to a further aspect of the strip tape, said first and second layers with outwardly facing surfaces of PP can be either homogeneous mono-layers of PP or PP copolymer or multi-layers having outwardly facing surfaces of PP or PP copolymer.

In a preferred embodiment, said first and second layers with outwardly facing surfaces of PP are multi-layers, each comprising a first outwardly facing part-layer of PP or PP copolymer, as well as second part-layers that are directly facing a respective one of the adhesive layers, and optionally one or more intermediate part-layer(s). Suitably, said second part-layers that are directly facing a respective one of the adhesive layers are constituted by a polymer in the group that consists of PP, graft PP, metallocene polyethylene, polyethylene copolymer (such as ethylene acrylic acid, “EAA” e.g.) and PP copolymer. It is conceivable that an optional intermediate part-layer is a layer having barrier ability against oxygen transmission. It is also conceivable that an optional intermediate part-layer is a polymer in the group that consists of a metallocene polyethylene and linear low density polyethylene (LLDPE). As an example, the structure could be, as seen from the outside and towards the adhesive layer: (PP or PP copolymer)/(metallocene PE or LLDPE)/EAA.

It is to be understood that in the present case, the possibility to use metallocene PP is included in the concept of the term PP, i.e. at all instances that PP is mentioned it may be ordinary PP or metallocene PP.

Preferably, said first and second layers with outwardly facing surfaces of PP are layers of (co)extruded blown films. It is also conceivable however that said first and second layers with outwardly facing surfaces of PP are layers of cast films, or that they are extrusion coated directly onto the adhesive layers.

According to yet another aspect of said first and second layers with outwardly facing surfaces of PP, each of the two layers have a total thickness of 10-50 μm, preferably20-40 μm and most preferred 22-28 μm.

Moreover, said first and second layers with outwardly facing surfaces of PP are identical with each other, although preferably being mirror-inverted if being constituted by multi-layers.

According to a further aspect of the invention, said first and second adhesive layers are preferably layers of polyurethane adhesive (solvent based or solventless), electron beam (EB) curable or ultraviolet (UV) curable adhesives. UV and EB curable adhesives give the benefit of immediate cure. The EB curable adhesive is applied as a liquid dispersion on the core layer film. The layer with an outwardly facing surface of PP is then immediately brought into contact (as a film or by extrusion) with it and the structure is passed into the EB curing chamber. High-energy electrons (at voltages of typically 100-300 kV) initiate polymerization of the reactive components within the adhesive. Upon exiting the EB curing chamber that is positioned in-line with the lamination line, the adhesive has cured to a solid adhesive layer, bonding to the core layer and the PP layer. In case a UV curable adhesive is used, the curing also takes place in a curing chamber in-line with the lamination line.

The first and second adhesive layers constitute the thinnest layers of the strip tape, preferably being thinner than 5 μm each and most preferred thinner than 3 μm each.

According to another aspect, said first and second adhesive layers are extrudable adhesive layers, or at least each comprises an extrudable adhesive part-layer, which part-layer preferably directly faces a respective one of said first and second layers with outwardly facing surfaces of PP.

It is also conceivable that the adhesive layers are instead very thin, i.e. thinner than 0.5 μm, in which case they may be denoted as “primer” layers. In the manufacturing process for the strip tape, the first and second adhesive layers are coated onto the core layer of an oxygen barrier polymer.

Preferably, said core layer of an oxygen barrier polymer is a layer of an extrudable oxygen barrier layer.

Preferably, said core layer of an oxygen barrier polymer is a layer of polyethylene terephtalate (PET), more preferred of biaxially oriented polyethylene terephtalate (BOPET). It is however also conceivable that said core layer of an oxygen barrier polymer is a layer of polyamide (PA) or ethylene vinyl alcohol (EVOH), either one preferably being biaxially oriented (BOPA, BOEVOH). The core layer has a thickness of 6-25 μm, preferably 8-19 μm and most preferred 10-15 μm.

According to yet another aspect of the invention, the strip tape has a total thickness of 35-120 μm, preferably50-80 μm and most preferred 60-70 μm.

The strip tape according to the invention is preferably pre-formed by adhesive lamination of three films, before it is slit into strip tapes of typically 6-10 mm width and applied to the packaging container for which it is intended. Alternatively, the strip tape may be manufactured by extrusion coating the outer PP layers onto the adhesive layers that have been coated onto the core layer, before the resulting film is slit as mentioned.

It is desired that the strip tape has an oxygen transmission rate of less than 120, preferably less than 100 cm³/(m²*24 h), 1 atm O₂. In case of a better oxygen barrier layer, such as a core layer of (BO)EVOH or an intermediate dedicated barrier layer in the first and second layers with outwardly facing surfaces of PP, the oxygen transmission rate is even lower, such as less than 70 and most preferred less than 50 cm³/(m²*24 h), 1 atm O₂.

Furthermore, the strip tape according to the invention can either, depending on the type of packaging container in which it is used, be continuously folded 180° about the first longitudinal edge of the packaging material, before the packaging material is cut into blanks and said first longitudinal edge is heat sealed on the inside of, and thus joined with, the second longitudinal edge, to form a sleeve with a longitudinal joint; or it can be continuously heat sealed essentially flat over said longitudinal joint, on the interior side of the packaging body, after or in connection with the heat sealing and thus formation of said joint, which in that case may be done continuously, i.e. not on blanks but by a continuous form-fill-seal process from a web of packaging material.

When the packaging container according to the invention is formed as a sleeve, from a blank of packaging material, it is preferably provided with a plastic top that comprises an opening device and that is heat sealed to the inside of the container body, at one end thereof, and hence the plastic top is heat sealed to a corresponding end of said longitudinal joint. In accordance with the objectives of the invention, the plastic top comprises outer layers of PP.

Preferably, the packaging container according to the invention is aseptic, preferably by sterilisation. Optionally, it may be retorted after having been filled and sealed.

### BRIEF DESCRIPTION OF THE ACCOMPANYING DRAWINGS

The present invention will now be described in greater detail herein below, with reference to one preferred embodiment and with reference to the accompanying Drawings. In the accompanying Drawings:

FIG. 1 is showing a cross-section of the structure of the preferred strip tape;

FIG. 2 is showing a blank of a packaging material with a strip tape applied on a longitudinal edge thereon;

FIG. 3 is showing a cross-section of an overlap joint in which the innermost longitudinal edge of the packaging material is protected by a strip tape;

FIG. 4 is showing a packaging container including a strip tape that protects its longitudinal joint.

### DESCRIPTION OF THE PREFERRED EMBODIMENT

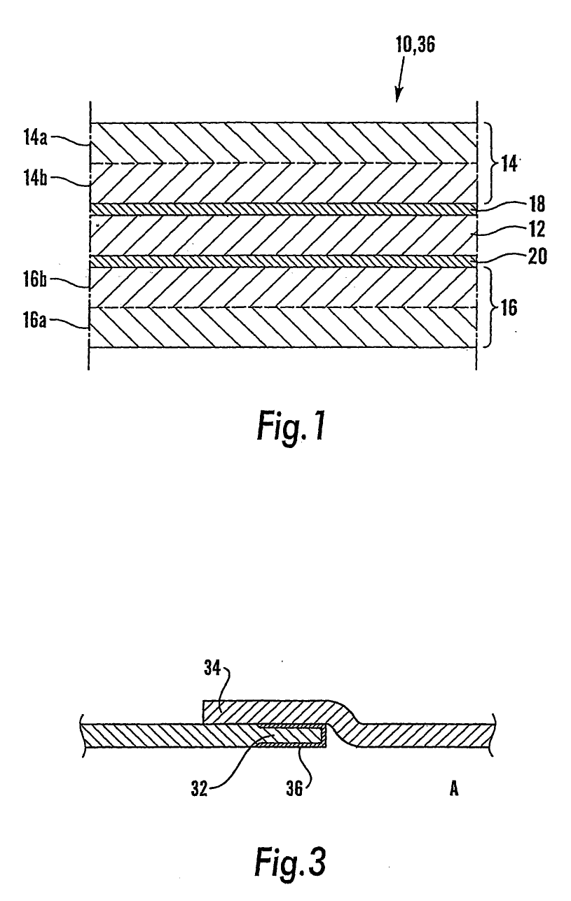

The preferred strip tape 36 according to the invention and shown in FIG. 1 is of symmetrical structure 10 and is made by adhesive lamination of three pre-made films 12, 14, 16. The pre-made core layer 12 has a thickness of 12 μm and is made of biaxially oriented PET film.

The outwardly facing surfaces of the strip tape 10 are constituted by PP part-layers 14a and 16a that have been co-extruded and blown together with graft PP part-layers 14b and 16b, respectively, to form the pre-made 25 μm films 14 and 16, respectively. The graft PP part-layers 14b and 16b are directly facing one adhesive layer 18, 20 each, and are adapted to bond well to these adhesive layers, due to-the grafted nature of the PP part-layers 14b, 16b. Examples of well functioning PP grades are Inspire 112 from Dow, Inspire 114 from Dow, Borclear RB707CF from Borealis, RB501BF from Borealis, BA110CF from Borealis, Daploy SF203HMS from Borealis, PP4352F1 from Exxon Mobil or PPH3060 from Atofina. An example of a well functioning graft PP grade is Admer QF830E from Mitsui.

The 2 μm adhesive layers 18, 20 are in turn directly facing (directly applied/coated on) said core layer 12. Examples of well functioning adhesive grades are SWIFT EC2 1340R/EC2 1367D—a polyurethane adhesive from Forbo Swift Adhesives SA, ADCOTE 545/Catalyst F—a polyurethane adhesive from Rohm&Haas, ADCOTE 545/Coreactant 200C from Rohm&Haas, ADCOTE 585K-60+Catalyst F—a polyurethane adhesive from Rohm&Haas, and MOR-FREE ELM 415A+CR-190—a polyurethane adhesive from Rohm&Haas. Examples of well functioning grades of EB-curable adhesive are 51345C and 52100 from Northwest Coatings LLC.

It should be understood of course that the cross-sectional structure will look the same as in FIG. 1 also in the case when the strip tape has been made by extrusion coating of 14 and 16 onto the adhesive layers 18, 20, as well as in the case of cast layers 14, 16. It should also be understood that the core layer 12, in alternative embodiments, can be constituted by another oxygen barrier polymer such as polyamide (PA) or ethylene vinyl alcohol (EVOH), either one preferably being biaxially oriented.

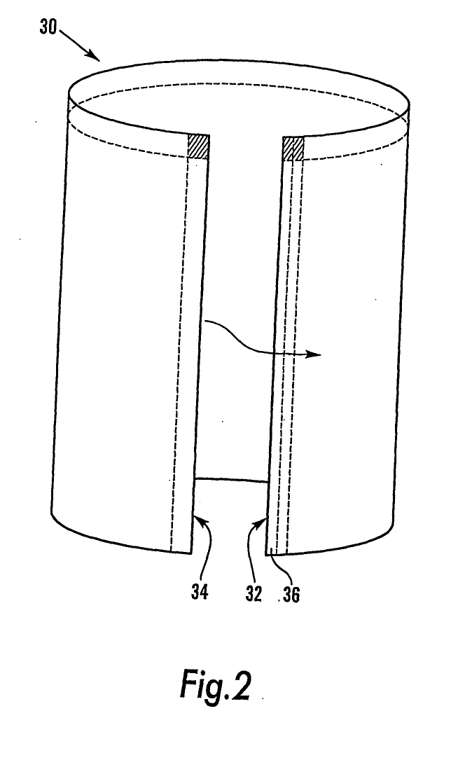

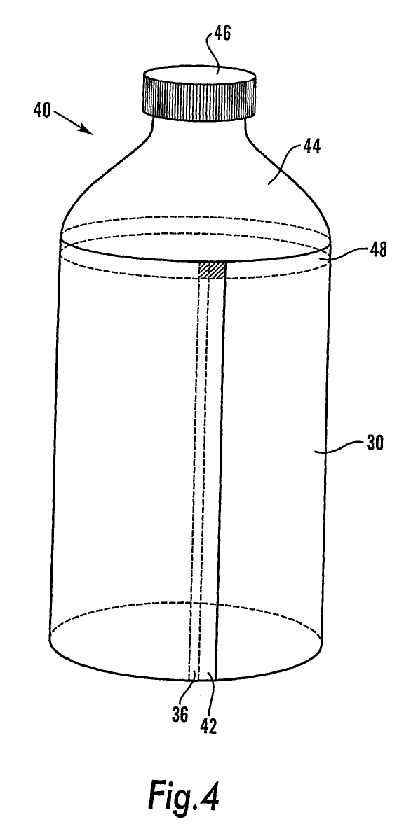

FIG. 2 is showing a blank of a packaging material 30, which blank is about to be formed to a tube, whereby a first longitudinal edge 32 of the packaging material ends up on the interior side of the tube and a second longitudinal edge 34 ends up on the outside of the tube, in the joint 42 to be formed, see. FIG. 4. In the preferred embodiment, the packaging material blank has the following cross-sectional structure, as seen from the inside of the tube/container body, and out: PP/Adhesive/Aluminium foil/LDPE/paperboard/PP. Many variants are however conceivable, all having in common though that they have a bulk layer of paperboard and an outwardly facing surface of PP.

The first longitudinal edge 32 of the packaging material in FIG. 2 is protected against food contact by a strip tape 36 according to the invention, which strip tape 36 has been folded 180° about the first longitudinal edge 32 and has been heat sealed thereto, on both sides of the first longitudinal edge 32, preferably by hot air and/or induction heat sealing. The upper end of the tube to be formed, and thus the upper end of the longitudinal joint, will be heat sealed to a top that includes an opening device, see FIG. 4, and the lower end of the tube will be fold-formed and heat sealed into a liquid-tight bottom.

FIG. 3 shows how the strip tape 36 protects the longitudinal edge 32 in the joint. Side A is the side that faces the interior of the packaging container and that accordingly will be exposed to the liquid food therein, and side B is the side that faces the exterior of the packaging container.

FIG. 4 is showing a packaging container 40 including a strip tape 36 that protects its longitudinal joint 42. A plastic top 44 is heat sealed 48 to the inside of the upper end of the paperboard based packaging material 30 that forms the tube or container body. The plastic top 44 exhibits an opening device 46. In the preferred embodiment, the plastic top has the following cross-sectional structure, as seen from the inside of the top, and out: PP/Adhesive/EVOH/Adhesive/PP. The outermost layer of PP is conveniently thicker than the innermost layer of PP. Many variants are however conceivable, all having in common though that they have an outwardly facing surface of PP.

The preferred embodiment of the strip tape of the invention has proven to function well in a filling machine for such an aseptic packaging container having paperboard based walls and bottom, and a plastic top. Specifically, the strip tape provided good sealing properties, heat stability and mechanical properties and did not result in structure damages due to the strip sealing about the edge of the packaging material. Furthermore, the strip tape exhibited an oxygen transmission rate of 100 cm³/(m²*24 h), 1 atm O₂.

1. A strip tape comprising, in order, a first layer with an outwardly facing surface of polypropylene, a first adhesive layer, a core layer of an oxygen barrier polymer, a second adhesive layer, and a second layer with an outwardly facing surface of polypropylene.

2. A strip tape according to claim 1, wherein said first and second layers with outwardly facing surfaces of polypropylene are identical with each other and are mirror-inverted in relation to each other.

3. A strip tape according to claim 1, wherein said first and second layers with outwardly facing surfaces of polypropylene are homogeneous mono-layers of polypropylene or polypropylene copolymer.

4. A strip tape according to claim 1, wherein said first and second layers with outwardly facing surfaces of polypropylene are multi-layers, each comprising a first outwardly facing part-layer of polypropylene or copolymer polypropylene, as well as second part-layers that are directly facing a respective one of the adhesive layers.

5. A strip tape according to claim 4, wherein said second part-layers that are directly facing a respective one of the adhesive layers are constituted by a polymer in the group that consists of polypropylene, graft polypropylene, metallocene polyethylene, polyethylene copolymer and polypropylene copolymer.

6. A strip tape according to claim 4, wherein an intermediate part-layer is between said first outwardly facing part-layer of polypropylene or copolymer polypropylene, and said second part-layer, the intermediate part-layer being constituted by a polymer in the group that consists of metallocene polyethylene and linear low density polyethylene.

7. A strip tape according to claim 1, wherein said first and second layers with outwardly facing surfaces of polypropylene are layers of extruded or coextruded blown films.

8. A strip tape according to claim 1, wherein said first and second layers with outwardly facing surfaces of polypropylene are layers of cast films.

9. A strip tape according to claim 1, wherein said first and second layers with outwardly facing surfaces of polypropylene are extrusion coated layers.

10. A strip tape according to claim 1, wherein said first and second layers with outwardly facing surfaces of polypropylene each have a thickness of 10-50 μm.

11. A strip tape according to claim 1, wherein said first and second adhesive layers are layers of a material in the group that consists of polyurethane adhesives, electron beam curable adhesives and ultraviolet curable adhesives.

12. A strip tape according to claim 1, wherein said first and second adhesive layers are thinner than all other layers of the strip tape, and are thinner than 5 μm each.

13. A strip tape according to claim 1, wherein said core layer of the oxygen barrier polymer is a layer of a polymer in the group that consists of polyethylene terephtalate, polyamide and ethylene vinyl alcohol.

14. A strip tape according to claim 1, wherein said core layer of the oxygen barrier polymer has a thickness of 6-25 μm.

15. A strip tape according to claim 1, wherein the strip tape has a total thickness of 35-120 μm.

16. A strip tape according to claim 1, wherein the strip tape has an oxygen transmission rate of less than 120 cm³/(m²*24 h), 1 atm O₂.

17. A packaging container comprised of a container body formed from a packaging material comprising a paper or paperboard core layer and outer heat sealable layers of polypropylene, a longitudinal joint in which first and second longitudinal edges of the packaging material overlap each other and are heat sealed to each other such that said first longitudinal edge faces an interior of the container body, said first longitudinal edge being protected by a strip tape that is heat sealed in an area of the joint, wherein said strip tape is a strip tape according to claim 1.

18. A packaging container according to claim 17, wherein said strip tape is folded 180° and heat sealed about said first longitudinal edge.

19. A packaging container according to claim 17, wherein said strip tape is sealed essentially flat over said longitudinal joint, on an interior side of the packaging body.

20. A packaging container according to claim 17, further comprising a plastic top that is heat sealed to an inside of the container body, at one end thereof, and hence to a corresponding end of said longitudinal joint, which plastic top has outer layers of polypropylene.

21. A packaging container according to claim 17, wherein the package container is aseptic.

22. A packaging container according to claim 17, wherein the packaging container is retorted.

23. A method of producing a strip tape, comprising applying a first adhesive layer to a first side of a core layer film of an oxygen barrier polymer, applying a second adhesive layer on a second side of the core layer film, extrusion coating a first layer with an outwardly facing surface of polypropylene onto said first adhesive layer, and extrusion coating a second layer with an outwardly facing surface of polypropylene onto said second adhesive layer.

24. A method of producing a strip tape comprising joining a first side of a core layer film of an oxygen barrier polymer with a first film having an outwardly facing surface of polypropylene by adhesive lamination with a first adhesive layer and joining a second side of the core layer film with a second film having an outwardly facing surface of polypropylene by adhesive lamination with a second adhesive layer.

25. A strip tape according to claim 1, wherein said first and second layers with outwardly facing surfaces of polypropylene each have a thickness of 20-40 μm.

26. A strip tape according to claim 1, wherein said first and second layers with outwardly facing surfaces of polypropylene each have a thickness of 22-28 μm.

27. A strip tape according to claim 1, wherein said first and second adhesive layers are thinner than all other layers of the strip tape, and are thinner than 3 μm each.

28. A strip tape according to claim 1, wherein said core layer of the oxygen barrier polymer is a layer of a polymer in the group that consists of a biaxially oriented polyethylene terephtalate, a biaxially oriented polyamide and a biaxially oriented ethylene vinyl alcohol.

29. A strip tape according to claim 1, wherein said core layer of the oxygen barrier polymer has a thickness of 8-19 μm.

30. A strip tape according to claim 1, wherein said core layer of the oxygen barrier polymer has a thickness of 10-15 μm.

31. A strip tape according to claim 1, wherein the strip tape has a total thickness of 50-80 μm.

32. A strip tape according to claim 1, wherein the strip tape has a total thickness of 60-70 μm.

33. A strip tape according to claim 1, wherein the strip tape has an oxygen transmission rate of less than 100 cm³/(m²*24 h), 1 atm O₂.
